(19) United States
(12) Patent Application Publication
(10) Pub. No.: US 2003/0020268 A1
(43) Pub. Date: Jan. 30, 2003

(54) Safety device for a motor vehicle

(75) Inventors: Friedrich Reiter, Sindelfingen (DE); Clark Ruedebusch, Renningen (DE)

Correspondence Address: CROWELL & MORING LLP, INTELLECTUAL PROPERTY GROUP, P.O. BOX 14300, WASHINGTON, DC, 20044-4300, US

(73) Assignee: Daimler Chrysler AG.

(21) Appl. No.: 10/200,223

(22) Filed: Jul. 23, 2002

(30) Foreign Application Priority Data
Jul. 25, 2001 (DE) 101 36 173.4-21

(51) Int. Cl. B60R 21/28

(52) U.S. Cl. 280/742

(57) ABSTRACT

A safety device for a motor vehicle includes a gas generator, an airbag which is to be filled by the gas generator in the event of an accident, an opening through which gas flows into or out of the airbag, and a mechanism operatively associated with the opening. The mechanism is configured to vary the flow resistance of the opening as a function of a pressure at a point of the safety device to increase the flow resistance of the opening as the pressure increases and to reduce the flow resistance of the opening as the pressure decreases. A method for operating a safety device for a motor vehicle includes the step of varying the flow resistance of an opening, through which gas flows into or out of an airbag of the safety device, as a function of a pressure at a point of the safety device. The method also includes the steps of increasing the flow resistance of the opening as the pressure increases and reducing the flow resistance of the opening as the pressure decreases.

This application claims the priority of German Patent No. 101 36 173.4-21, filed Jul. 25, 2001, the disclosure of which is expressly incorporated by reference herein.

### BACKGROUND AND SUMMARY OF THE INVENTION

The invention relates to a safety device for a motor vehicle having a gas generator and an airbag which is to be filled by the gas generator in the event of an accident, the safety device having at least one opening for the inflow and/or outflow of gas and a mechanism/method for varying the flow resistance of the opening.

A safety device is disclosed, for example in EP 0 917 994 A1. The opening of the airbag is arranged in the meridian region of the bag. Guided around the opening is a thread with a loop, and the thread is arranged in a linearly displaceable manner in guides. The ends of the thread are arranged in that region of the airbag which experience has shown expands the greatest when a vehicle occupant plunges into it.

If a vehicle occupant plunges into the filled airbag, whereupon the bag expands at least in subregions, the distance between the two ends of the thread increases. As a result, the loop extending around the opening is contracted and the cross section of the opening is therefore reduced. In the case of the known safety device, the size of the flow cross section, and therefore of the flow resistance, is thus regulated as a function of the expansion of certain subregions of the airbag.

However, a disadvantage of this safety device is that the control only becomes effective if the vehicle occupant strikes against the airbag in such a manner that the regions in which the ends of the thread are arranged are expanded. If this is not the case (for example, if the occupant takes up an “out of position” position during unfolding of the airbag) or if, when he plunges into the airbag, a completely different region of the airbag is stressed and expanded, the distance between the two ends does not change and the desired regulation fails to materialize. A further disadvantage of the known solution is that the realization is very complex if a reliable and error-free guiding of the thread is to be obtained.

Furthermore, German utility model DE 88 00 530 U1 discloses an airbag, the opening of which is closed by closing parts which are made of elastic, deformable material and which have a recess. The recess in the closing part changes its cross section as a function of the internal pressure in the air cushion, i.e. the cross section is largest when the airbag is filled to the maximum and the size of the airbag decreases continuously as the airbag empties. Thus, in the case of a severely loaded airbag, a large amount of gas can escape and in the case of a low pressure—i.e. less severe loading of the airbag—a small amount of gas can escape.

For optimum protection of the vehicle occupants it is advantageous, however, if in the case of a severe accident and therefore severe loading of the airbag, the airbag is harder in order to absorb more energy. In the case of a less severe accident, a softer airbag is advantageous in order to avoid unnecessary loads on the occupant. The same applies for different types of loads due to the different weights of vehicle occupants.

Against this prior art background, the present invention is based on the object of providing a safety device, in which the reliability of the control is improved and an optimum protection for the vehicle occupants is achieved.

According to the invention, this object is achieved by a safety device of the present invention as described hereinafter.

In accordance with the present invention, the regulation of the flow resistance, for example by regulating the flow cross section, takes place as a function of a pressure at a certain point in the safety device. The pressure in the airbag always is associated with the load on the airbag. It is dependent on how much gas flows into the airbag but also on how strongly the person impacts the airbag. The pressure in the gas generator is dependent on the phase of the deployment of the airbag and on how much gas has already flowed out of the gas generator. Thus, at a certain point in the safety device the pressure in the airbag and in the gas generator therefore is a reliable indicator of the state of the safety device. With the aid of this indicator, a reliable regulation adapted in an infinitely variable manner to different types of load can be obtained.

According to the invention, the flow resistance increases as the pressure in the safety system rises and decreases as the pressure drops. This results in the following regulating sequences in the use of the safety device according to the invention. If the airbag is severely stressed, for example in the case of a severe accident or because of a high weight of a vehicle occupant, a high pressure arises in the airbag, resulting in increased flow resistance to outflow. Since less gas can escape, the airbag remains hard and can absorb a relatively large amount of energy.

If the airbag is not so severely stressed, for example in the case of a slight accident or because of a light vehicle occupant, then a lower pressure arises in the airbag. This has the consequence of reducing the flow resistance, with the result that more gas can escape and the airbag is softer. This is advantageous in the case of slight accident and/or light weight because it is not necessary to absorb as much energy and an airbag which is too hard may cause an unnecessarily severe load on the occupant.

The previously described principle can be further reinforced by the effects of the law of Bernoulli's pressure equation, according to which the sum of the static, kinetic and geodetic pressure is constant for flowing fluids. This means that the flow resistance is set not only via the mechanism for varying the size of the flow cross section, but also as a function of the flow speed of the gas passing through the opening.

According to one embodiment of the invention, the mechanism for varying the flow resistance set the flow resistance automatically. This means that apart from the mechanism for varying the flow resistance no other regulating and control devices are provided. This results in a simple and therefore cost-effective and less temperamental construction. However, it is also conceivable to provide a control and/or regulating unit, for example in electronic or mechanical form, the input variable of which is the pressure in the safety device and which produces, as an output variable, a suitable adjusting variable for the flow resistance.

The opening for the inflow and/or outflow of gas into/from the safety device can be of tubular design. With the opening shaped in such a manner the mechanism for varying the flow resistance can act in a particularly favorable manner.

The mechanism for varying the flow resistance can be connected to a selected point of the safety device, with the result that pressure equalization can take place. A connection of this type can comprise, for example, a flexible tube which connects the components directly to one another. This has the effect that the pressure which prevails, for example, in the airbag and/or the gas generator is set directly in the mechanism for varying the flow resistance.

According to one embodiment, the mechanism for varying the flow resistance is designed as an annular flexible tube which is formed around the tubular opening. In this position, the annular flexible tube can act in a very simple manner on the cross section of the opening. If the diameter of the flexible tube is variable, the expansion of the said flexible tube can be varied via the pressure in the airbag and gas generator, and therefore via the pressure in the annular flexible tube. Since the annular flexible tube is guided around the opening, a change in the expansion of the flexible tube has an effect on the flow cross section and therefore the flow resistance of the opening. For this purpose, the flexible tube may, for example, be of elastic design. However, it is also conceivable for it to have a folded structure which is unfolded or folded depending on the pressure. The expansion of the annular flexible tube is changed in turn by these folding processes. If the expansion of the annular flexible tube takes place reversibly, a particularly reliable control can be obtained.

The annular flexible tube may have equalizing openings to provide an additional coordination possibility and to adjust excess pressure. The flexible tube can also comprise a pneumatic actuator, such as a flexible tube which is shortened or lengthened during a change in pressure. If other control and regulating units are used, the use of a hydraulic actuator is also conceivable.

According to a further embodiment, the mechanism for varying the flow resistance can be designed as a unit which has a variable volume and lies in the tubular opening. If this unit expands, the flow cross section is reduced, and if it contracts, the flow cross section is increased. The unit can be opened towards the airbag. As a result, a direct pressure-equalizing connection between the airbag and unit with variable volume is provided.

However, it is also conceivable for the unit to be connected in addition, or exclusively, to the gas generator. This can take place, for example, via a flexible tube as in the previously described exemplary embodiment. The end of the unit which points away from the airbag is preferably closed in order to retain the pressure given up by the airbag and/or gas generator.

Likewise as in the previously described exemplary embodiment, the unit which has a variable volume can be of elastic design or can have a folded structure.

It is also conceivable to make at least one equalizing opening in the unit. At least part of the excess pressure arising in the mechanism for varying the flow cross section can be removed through the opening to provide an additional coordination possibility for the system.

The unit with variable volume can be arranged within the tubular opening. The gas flowing in or out then passes the outside of the unit. To prevent the unit from blocking the tubular opening, it can be held in the centre of the opening with the aid of a fastening arrangement. However, the unit can also extend around the circumference of the tubular opening or even form the circumference. In this case, the gas flowing in or out flows through the unit.

According to a further embodiment, the mechanism for varying the flow cross section can also be designed as elements which are arranged moveably in the opening. The size of the flow cross section is a function of the position of the element in the opening. Conceivable embodiments of a moveable element of this type can be slides, levers and/or flaps. These can be spring-loaded in order to permit automatic regulation. In the case of this embodiment, the regulating effect can be reinforced or weakened in a particularly simple manner.

All of the embodiments described can also be combined with one another. Similarly, all of the embodiments can be used inter alia in a stepped filling process using a multi-stage gas generator. The mechanism for varying the flow resistance can be configured as desired with regard to number, position, geometry, material and shapes.

Other objects, advantages and novel features of the present invention will become apparent from the following detailed description of the invention when considered in conjunction with the accompanying drawings.

### BRIEF DESCRIPTION OF THE DRAWINGS

The invention will be explained in greater detail below with reference to the exemplary embodiments illustrated in the drawing, in which:

FIG. 1 shows a schematic illustration of a safety device according to the invention, in which the mechanism for varying the flow resistance are designed as an annular flexible tube;

FIG. 2 shows a cross section of an opening of a safety device according to FIG. 1;

FIG. 3a shows a schematic illustration of a safety device according to the invention, in which the mechanism for varying the flow resistance are designed as a unit which has a variable volume and is arranged centrally in the opening;

FIG. 3b shows a cross section of an opening of a safety device according to FIG. 3a;

FIG. 4 shows a cross section of a safety device according to the invention, in which the mechanism for varying the flow resistance are designed as a unit which has a variable volume and is arranged around the opening;

FIG. 5 shows a schematic illustration of a safety device having an annular flexible tube as the mechanism for varying the flow resistance, which tube extends around an inflow opening, and

FIG. 6 shows a schematic illustration of a safety device, in which the mechanism for varying the flow resistance are designed as an element which is arranged moveably.

### DETAILED DESCRIPTION OF THE DRAWINGS

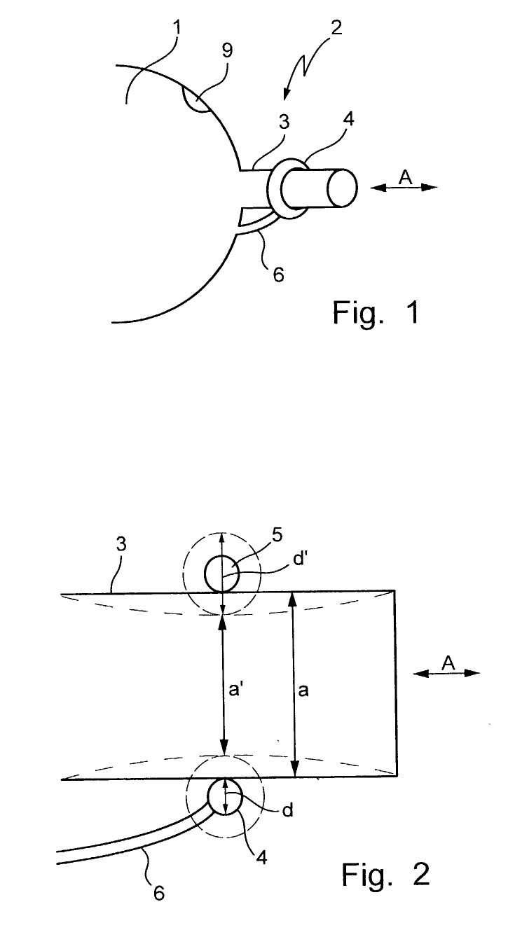

FIG. 1 schematically illustrates an airbag 1 of a safety device 2 according to the invention. For reasons of clarity, the illustration of the gas generator has been omitted. The airbag has an opening 3 of tubular design. The opening may be an inflow opening or an outflow opening, and gas in the opening can flow in either direction as illustrated by the double arrow A. A conventional opening 9 can also be made in the airbag 1.

An annular flexible tube 4 is arranged around the tubular opening 3. The flexible tube 4 is, as shown in FIG. 2, hollow and encloses a cavity 5. The flexible tube 4 is connected to the airbag 1 via a connection 6 which is likewise hollow. The pressure in the flexible tube 4 is made equal to the pressure in the airbag 1 by the connection 6.

The flexible tube 4 has a variable diameter d and d′. FIG. 2 illustrates two different states of the flexible tube 4. The solid line illustrates the flexible tube 4 with a small diameter d and the dashed line illustrates the flexible tube 4 with a larger diameter d′. The flexible tube 4 is arranged around the opening 3 in such a manner that the change in the diameter d of the flexible tube 4 has an effect on the flow cross section a, and therefore on the flow resistance, of the opening 3. If the diameter d of the flexible tube 4 is small, the flow cross section a of the opening is at a maximum and its flow resistance is at a minimum. If, in contrast, the diameter d′ of the flexible tube 4 is large, the flow cross section a′ of the opening 3 is small and its flow resistance is larger.

The following regulating sequences can be used with this arrangement. If the pressure in the airbag 1 is large, the flexible tube 4 expands, and the opening 3 is minimized. As a result, only a small amount of gas can escape and the pressure in the airbag 1 remains at a maximum or decreases slowly than without the regulation. Depending on the amount of the gas in-flow, the pressure can also increase. This state is produced, for example, in the case of a severe accident when the occupant is pressed with a great force into the airbag, or in the case of a heavy occupant. For this type of load, a hard airbag 1 provides the optimum protection because it intercepts the large load and can simultaneously absorb a large amount of energy.

If the pressure in the airbag 1 is small, the flexible tube 4 does not expand and the flow cross section a is at a maximum. A large amount of gas can escape. This case occurs in the event of a slight accident or a light occupant. With such a type of load, the airbag 1 is not very severely loaded and so the pressure is not as high. In these cases, an airbag which is not so fully filled is advantageous because the occupant is not subjected to unnecessary loads.

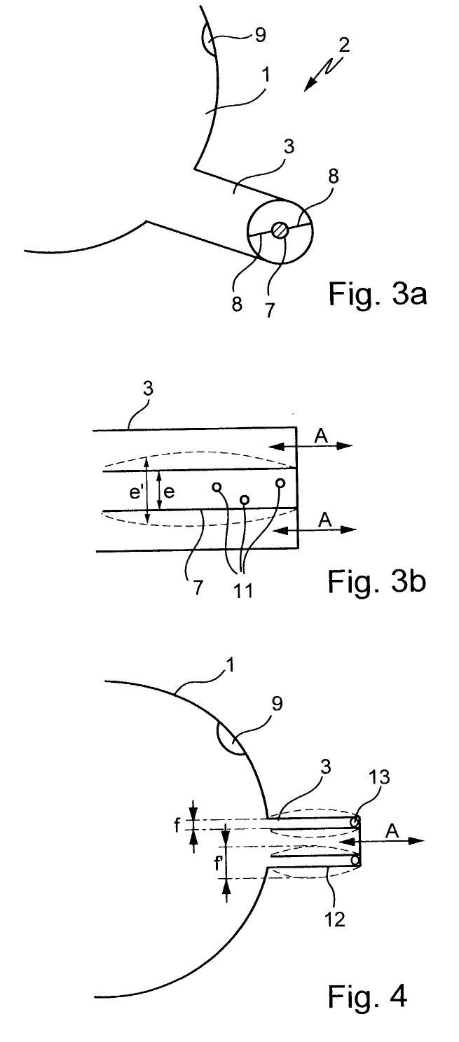

FIGS. 3a and 3b illustrate a further exemplary embodiment of the safety device 2 according to the invention. This is distinguished in that the mechanism for varying the flow cross section comprise a flexible tube 7. The flexible tube 7 is arranged in the centre of the opening 3, and the flow cross section of the opening 3 is composed of the area surrounding the flexible tube 7. The flexible tube 7 is opened towards the airbag 1, so that the pressure in the airbag is transferred directly onto the flexible tube 7. It is also conceivable for the flexible tube 7 to be connected to a gas generator (not illustrated) directly or via a suitable connection. The flexible tube 7 can be connected to the opening 3 via a fastening element 8. This maintains the tube's central position and does not block the flow cross section of the opening.

As illustrated in FIG. 3b by a dashed line, the diameter e of the flexible tube 7 is variable. It can also expand to a diameter e′. A change in the diameter e of the flexible tube 7 causes a change in the flow cross section of the opening 3. In this embodiment, the regulating interrelationship is the same as in the case of the previously described embodiments. In the case of a high pressure in the airbag 1 or in the gas generator, the flow cross section is reduced, and a low pressure increases the flow cross section. Equalizing holes 11 can be made in the flexible tube 7.

In the exemplary embodiment illustrated in FIG. 4, the mechanism for varying the flow cross section is designed as a flexible tube element 12 surrounding the opening 3. The mechanism's opening faces the airbag 1 in order to permit the necessary pressure equalization. However, this is also possible again via other suitable pressure-equalizing means. The other end of the flexible tube element 12 is closed. However, again equalizing openings 13 can also be provided. The dashed line illustrates the changing dimensions f and f of the flexible tube element 12 to change the size of the flow cross section of the opening 3.

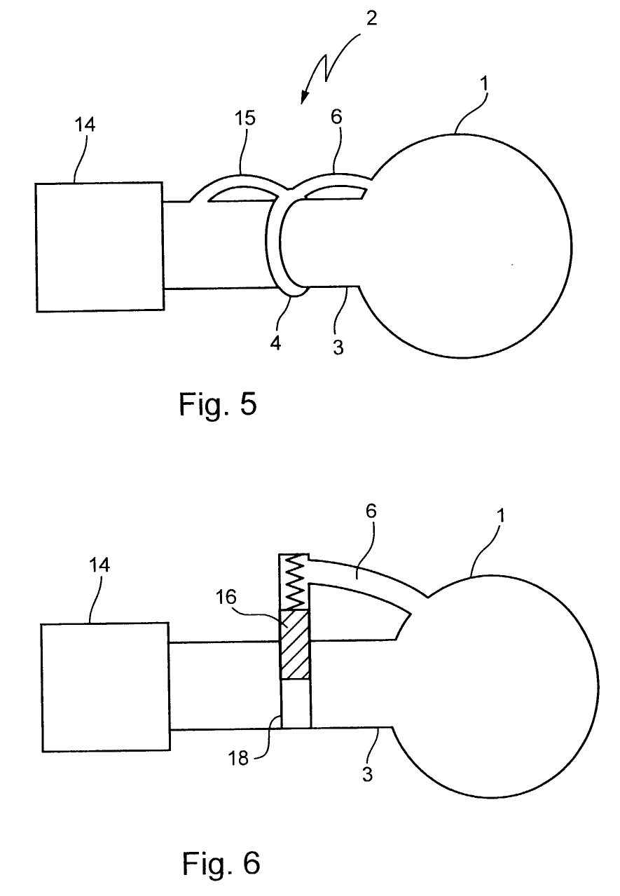

FIG. 5 illustrates an annular flexible tube 4 which corresponds to the one in FIG. 1 and is arranged around an opening 3. The case illustrated involves an inflow opening 3 connecting a gas generator 14 to the airbag 1. The flexible tube 4 is not only connected to the airbag 1 via the connecting element 6, but also to the gas generator 14 via a further connecting element 15. The connecting elements 6 and 15 can also be provided with external devices for flowing against and/or with flow filters and/or control/regulating devices, such as flaps. With the aid of this arrangement a high pressure—frequently occurring in the initial phase of the deployment of the airbag—in the gas generator can be constricted. The high pressure in the gas generator causes an increase in the diameter of the flexible tube 4, as a result of which the opening 3 is contracted. This in turn prevents the high pressure of the gas generator 14 from being conducted directly into the airbag 1, since initially only a relatively small flow of gas can enter the airbag 1. During the subsequent deflation of the airbag, this can take place via the same regulating device which is used for the inflation. Via a control which depends on the direction of flow, the regulating characteristic curve can be changed and an outflow opening can be opened up, which opening can be closed during the inflation process.

FIG. 6 illustrates a further exemplary embodiment. In this embodiment, the mechanism for varying the flow cross section is designed as an element 16 which is moveable in the tubular opening 3. The element 16 has the form of a slide. The slide is acted upon by a spring 17 and is mounted in a guide 18. The slide 16 is connected to the airbag 1 via a line 6, with the result that the pressure in the airbag 1 acts directly on the slide 16. It is also conceivable for a further connecting element to be provided, which element is guided from the gas generator 14 to the slide 16 and thereby obtains the regulating effect previously outlined. As the pressure in the airbag 1 rises, the slide moves in the direction of the closing position, reducing the flow cross section of the opening 3. In the process, the slide 16 is moved counter to the force of the spring 17. As soon as the pressure eases off, the spring force the slide 16 to move back in the direction of an opening position and thereby open up the flow cross section again.

A complete closure of the opening 3 can be prevented by a device which is placed into the opening and which ensures minimal leakage, for example a spacer of suitable shape, such as a cross shape. An additional coordination of the system is also possible via these elements. Furthermore, a pulsating outflow behaviour (“buffeting”) is thereby prevented or reduced.

Measures which interfere with the flow can be inserted into the opening in order to reinforce the increasing flow resistance. This also enables a transition from laminar to turbulent flow, and hence a sudden increase in the flow resistance, to be achieved.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Safety device for a motor vehicle having a gas generator and an airbag which is to be filled by the gas generator in the event of an accident, the safety device having at least one opening for the inflow and/or outflow of gas and means for varying the flow resistance of the opening, wherein the size of the flow resistance is set as a function of a pressure at a point of the safety device in such a manner that the flow resistance of the opening is increased as the pressure rises and is reduced as the pressure drops.

2. Safety device according to claim 1, wherein the means for varying the flow resistance automatically set the flow resistance.

3. Safety device according to claim 1, wherein the opening (3) is tubular.

4. Safety device according to claim 1, wherein the means for varying the flow resistance are connected to at least one of the airbag, the gas generator and supply lines, so that pressure equalization between these components takes place.

5. Safety device according to claim 3, wherein the means for varying the flow resistance are an annular flexible tube surrounding the tubular opening.

6. Safety device according to claim 5, wherein the diameter of the flexible tube is variable.

7. Safety device according to claim 5, wherein the flexible tube is of elastic design.

8. Safety device according to claim 5, wherein the flexible tube has a folded structure.

9. Safety device according to claim 5, wherein the flexible tube has an equalizing opening.

10. Safety device according to claim 3, wherein the means for varying the flow resistance includes a unit which has a variable volume and lies in the tubular opening.

11. Safety device according to claim 10, wherein the unit is open towards the airbag and is closed at its end pointing away from the airbag.

12. Safety device according to claim 10, wherein the unit is of elastic design.

13. Safety device according to claim 10, wherein the unit has a folded structure.

14. Safety device according to claim 10, wherein the unit has an equalizing opening.

15. Safety device according to claim 10, wherein the unit is arranged within the tubular opening.

16. Safety device according to claim 10, wherein the unit extends along the circumference of the tubular opening.

17. Safety device according to claim 1, wherein the means for varying the flow resistance includes an element which is arranged moveably in the opening.

18. Safety device according to claim 17, wherein the element which is arranged moveably includes at least one of a slide, lever and flap.

19. Safety device according to claim 17, wherein the element which is arranged moveably is spring-loaded.

20. Safety device according to claim 1, wherein a regulating characteristic curve depends on the direction of flow.

21. A safety device for a motor vehicle comprising:
a gas generator;
an airbag which is to be filled by the gas generator in the event of an accident;
an opening through which gas flows into or out of the airbag; and
a mechanism operatively associated with the opening, wherein the mechanism is configured to vary the flow resistance of the opening as a function of a pressure at a point of the safety device to increase the flow resistance of the opening as the pressure increases and to reduce the flow resistance of the opening as the pressure decreases.

22. The safety device according to claim 21, wherein the opening is tubular.

23. The safety device according to claim 21, wherein the mechanism is in fluid communication with at least one of the airbag and the gas generator so that the mechanism adjusts the flow resistance of the opening as a function of the pressure at the at least one of the airbag and the gas generator.

24. The safety device according to claim 21, wherein a regulating characteristic curve depends on the direction of flow.

25. A safety device for a motor vehicle comprising:
a gas generator;
an airbag which is to be filled by the gas generator in the event of an accident;
a tubular opening through which gas flows into or out of the airbag; and
a mechanism having a variable volume and operatively associated with the tubular opening, wherein the volume of the mechanism varies as a function of a pressure at a point of the safety device to adjust the flow resistance of the tubular opening, wherein the mechanism increases the flow resistance of the tubular opening as the pressure increases and to reduce the flow resistance of the tubular opening as the pressure decreases.

26. The safety device according to claim 25, wherein the mechanism is in fluid communication with at least one of the airbag and the gas generator so that the mechanism varies the flow resistance of the opening as a function of the pressure at the at least one of the airbag and the gas generator.

27. The safety device according to claim 25, wherein the mechanism includes an annular flexible tube surrounding the tubular opening to vary the flow resistance of the tubular opening.

28. The safety device according to claim 27, wherein the diameter of the flexible tube is variable.

29. The safety device according to claim 27, wherein the flexible tube is of elastic design.

30. The safety device according to claim 27, wherein the flexible tube has a folded structure.

31. The safety device according to claim 27, wherein the flexible tube has an opening for fluid communication with another component of the safety device.

32. The safety device according to claim 24, wherein the mechanism includes a unit disposed in the tubular opening.

33. The safety device according to claim 32, wherein the unit has two ends, wherein the unit is in fluid communication with the airbag through one of the ends, and the other end is closed.

34. The safety device according to claim 32, wherein the unit is of elastic design.

35. The safety device according to claim 32, wherein the unit has a folded structure.

36. The safety device according to claim 32, wherein the unit has an opening for fluid communication with another component of the safety device.

37. The safety device according to claim 32, wherein the unit extends along the circumference of the tubular opening.

38. A safety device for a motor vehicle comprising:
a gas generator;
an airbag which is to be filled by the gas generator in the event of an accident;
an opening through which gas flows into or out of the airbag; and
an element arranged moveably in the opening, wherein the position of the element inside the opening varies as a function of a pressure at a point of the safety device to adjust the flow resistance of the opening, wherein the element increases the flow resistance of the opening as the pressure increases and to reduce the flow resistance of the opening as the pressure decreases.

39. The safety device according to claim 38, wherein the element includes at least one of a slide, lever and flap.

40. The safety device according to claim 38, wherein the element is spring-loaded.

41. The safety device according to claim 38, wherein the position of the element is controlled by the pressure at at least one of the airbag and the gas generator to vary the flow resistance of the opening as a function of the pressure at the at least one of the airbag and the gas generator.

42. A method for operating a safety device for a motor vehicle comprising:
varying the flow resistance of an opening, through which gas flows into or out of an airbag of the safety device, as a function of a pressure at a point of the safety device;
increasing the flow resistance of the opening as the pressure increases; and
reducing the flow resistance of the opening as the pressure decreases.

43. The method according to claim 42, wherein the opening is tubular.

44. The safety device according to claim 42, wherein the step of varying the flow resistance of the opening includes varying the flow resistance of the opening as a function of the pressure at at least one of the airbag and the gas generator.
